(19) United States
(12) Patent Application Publication
(10) Pub. No.: US 2013/0290012 A1
(43) Pub. Date: Oct. 31, 2013

(54) METHOD AND SYSTEM FOR DELIVERING PATIENT SPECIFIC CONTENT

(71) Applicant: Joseph K. Weidner, JR., Rising Sun, MD (US)

(72) Inventor: Joseph K. Weidner, JR., Rising Sun, MD (US)

(21) Appl. No.: 13/864,593

(22) Filed: Apr. 17, 2013

Related U.S. Application Data
(63) Continuation of application No. 13/774,032, filed on Feb. 22, 2013.
Application No. 13/774,032 is a continuation-in-part of application No. 13/385,485, filed on Feb. 22, 2012.

(51) Int. Cl. G06F 19/00

(52) U.S. Cl. CPC G06F 19/325
USPC 705/2

(57) ABSTRACT

A method of providing patient specific content includes storing desired health related information; obtaining patient characteristics; obtaining health related information in accordance with the patient characteristics; and providing the obtained health related information to the patient.

### RELATED CASE

This application is a continuation of U.S. patent application Ser. No. 13/774,032 filed on 22 Feb. 2013, which is a continuation-in-part of U.S. patent application Ser. No. 13/385,485 filed 22 Feb. 2012, entitled METHOD AND SYSTEM FOR DELIVERING PATIENT SPECIFIC CONTENT AT A POINT OF CARE, the contents of which are all incorporated by reference.

### TECHNICAL FIELD

The present disclosure generally relates to a patient education and in particular, providing patient specific content to a patient.

### BACKGROUND

Patient education is an important part of patient care. Commonly, patents are given pamphlets or other reading material to aid in their understanding of a diagnosis of their condition. In many instances, such material is not used by the patient. Patients sometimes postpone reading to a convenient time, which commonly never arrives.

Thus, there is a need to provide patient education in a form where patient procrastination is less likely to prevent a patent from reading educational material

### SUMMARY OF DISCLOSURE

In one implementation, a method of providing patient specific content includes storing desired health related information; obtaining patient characteristics; obtaining health related information in accordance with the patient characteristics; and providing the obtained health related information to the patient.

One or more of the following features may be included. Storing desired health related information may include storing in a database health specific and practice specific content, and storing in the database links to health specific and practice specific content. Storing desired health related information may include storing health content and links to health content generated by specific practice and physician users. Specific codes may be applied to the health specific content, including tagging the health specific content with existing diagnosis codes or other health identifiers. Gender, age and other demographic codes may be applied to the health specific content. Tagging the health specific content may be based at least in part upon one or more of: disease management, disease and injury prevention, disease screening, health recommendations, practice policies, practice promotions, and entertainment.

Providing the obtained health related information may be in accordance with predetermined rules. The predetermined rules may include one or more of: practice determined permissions to content to require or forbid providing predetermined health specific content; physician determined permissions to content to require or forbid providing predetermined health specific content; categories of specific applied diagnosis and demographic codes that correspond with specific diagnosis and demographic codes of the health specific content; and a specific physician specialty for each category to limit the use of the health specific content to a specified category to the physicians of that specialty. The categories may include at least one of creation, management, and selection of categories by the practice and physician, designation of appropriate physician specialty, selection of disease and demographic codes to the categories by a practice and physician, diagnosis codes in common with the categories.

Obtaining health related information may include running a script that performs at least one of: queries the database by a patient identifier to obtain demographics and diagnosis codes, selects the health specific content based on at least one of demographics and diagnosis codes within an electronic medical record database; and selects practice-specific and physician specific health specific content. Identification of the patient may be obtained and entered the identification into a database. At least a plurality of a patient identifier, an exam room, and physician may be selected and entering into a database. At least one diagnosis category may be selected and entered into a database. Patient characteristics may be entered into a database. The method of claim 10 wherein providing the obtained health related information includes displaying the obtained health related information on a browser based on a predetermined device identifier.

A prompt may be displayed on a display running a browser to enter patient interaction and receiving the patient interaction information. Instructions may be displayed on the device to enter into the device patient information including at least one of phone, email and contact information, and receiving the patient information. A link of query strings may be sent that corresponds to the patient's information.

Reports of patient viewing and interaction of content may be generated. Generating reports may include generating reports based on patient interaction and usage data. Generating reports may include storing patient interaction data in a patient record within an electronic medical record. Providing the obtained health related information to the patient may include providing the obtained health related information to the patient at the point of care. Providing the obtained health related information to the patient may include providing the obtained health related information to the patient at a remote location.

In another implementation, a method of providing patient specific content includes: storing desired health related information; obtaining patient characteristics; obtaining health related information in accordance with the patient characteristics; and providing the obtained health related information to the patient at the point of care.

In another implementation, a method of providing patient specific content includes: storing desired health related information; obtaining patient characteristics; obtaining health related information in accordance with the patient characteristics; and providing the obtained health related information to the patient at a remote location.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a schematic view of a general system in accordance with the present disclosure;

FIG. 2 is a flow diagram of an embodiment of a method in accordance with the present disclosure;

FIG. 3 is an example browser for entering patient information;

FIG. 3A is an alternative example browser for entering patient information;

FIG. 4 schematically illustrates the relationships of media content and a patient characteristic in a database;

FIG. 5 schematically illustrates media can be associated with categories, according to the diagnostic codes that associated with the categories;

FIG. 6 schematically illustrates how rules can be applied to determine media content to be displayed; and

FIG. 7 schematically illustrates an example of the rules used to determine the media content that is displayed.

Like reference symbols in the various drawings indicate like elements.

### DETAILED DESCRIPTION OF THE PREFERRED EMBODIMENTS

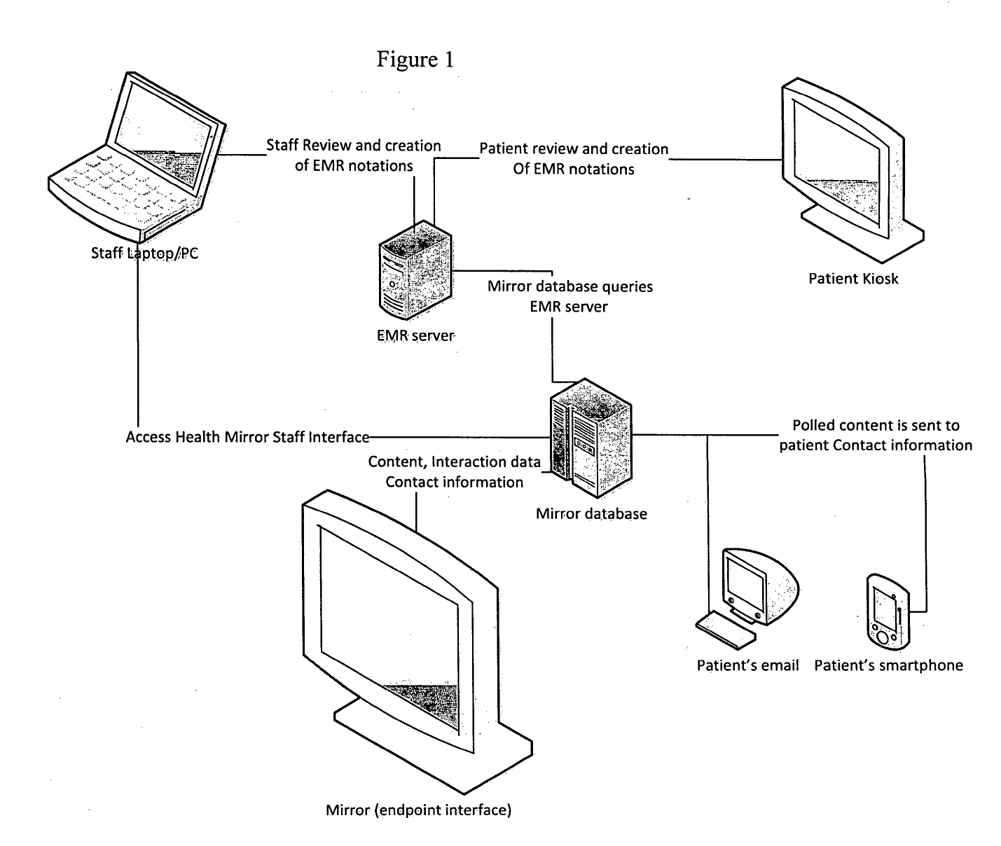

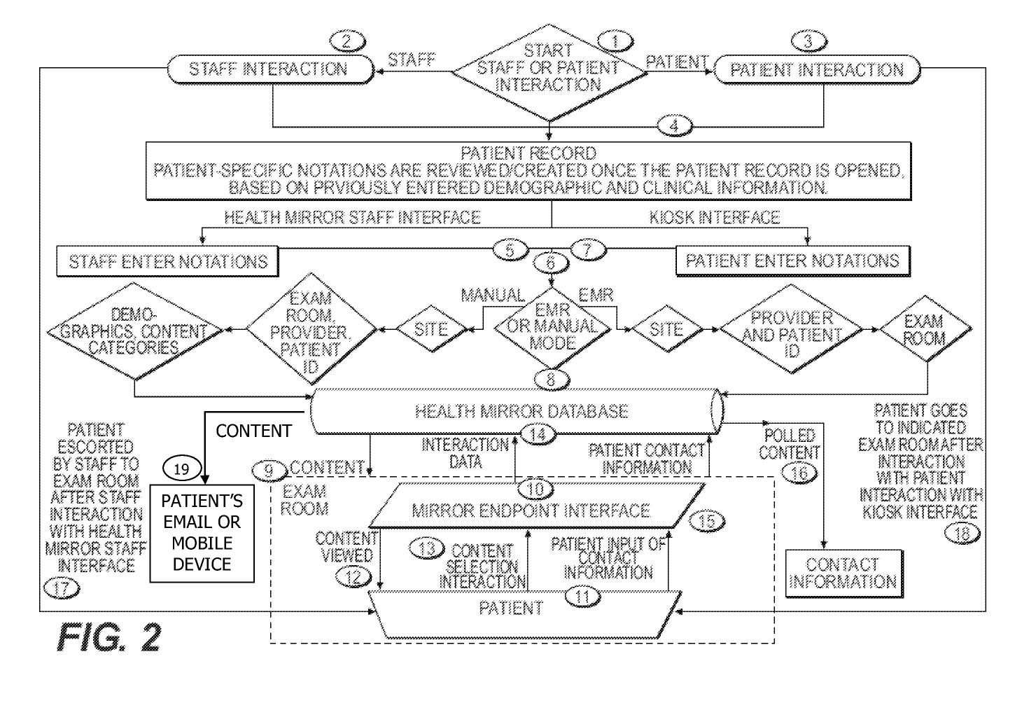

FIG. 1 is a schematic view of a general system in accordance with the present disclosure. FIG. 1 illustrates the general logic connections for communications within an embodiment of the present invention. In FIG. 1, the staff computing device (e.g., a laptop, desktop, tablet or other input device) can be used to enter patient information, including patient characteristics, as described with respect to FIG. 2 below. Alternatively, a patient kiosk can be used to enter patient information, including patient characteristics, as described with respect to FIG. 2 below.

In an embodiment, patient information is sent to an electronic medical records (EMR) server that can include or have a separate database (Mirror database) that stores patient information in accordance with embodiments of the present invention, as shown in FIG. 1. The Mirror database can be but does not need to be separate from the EMR server. FIG. 1 illustrates an example display that would be located in an exam room, and which can run a browser to display information and allows interaction with a patient via, e.g., a touch screen, mouse or other input device such as a keyboard. In accordance with an embodiment, each display has an identification that allows information to be sent to a specified display. FIG. 1 also schematically illustrates messages, such as follow-up inquiries or reminders to a patient's e-mail or smartphone.

FIG. 2 is a flow diagram of an embodiment of a method in accordance with the present disclosure. Referring to FIG. 2, this diagram illustrates an example operation of an embodiment in accordance with the present invention. FIG. 2 schematically illustrates an example workflow. At the beginning of the process (1), when the patient visits the office practice, the patient may check in via a staff or patient interaction. The office staff would interact using an input device such as mentioned above with respect to FIG. 1, by opening the patient record. (2) Alternatively, the patient would check-in through interaction through an interface, such as an office Kiosk or tablet device. (3) Patient specific notations that have been previously entered into the patient record (stored in, for example, the database shown in FIG. 1) are reviewed in the patient record, by the staff or by the patient. Staff or patient created notations also contribute to the patient information utilized by the system to obtain patient specific content. (4) A decision by the user (staff or patient) would be made at the interface with the EMR to enter notations not currently populated by the EMR. (5) Next, additional notations are entered into the device interface by the staff, as needed and not otherwise provided by the EMR. (6) These notations could include the practice site, a patient identifier, the care provider (e.g., physician), the exam room the patient is assigned, the patient demographics, and the categories of content appropriate for that patient. Alternatively, a patient can enter similar notations through an interface (such as a Kiosk, tablet, or mobile device) (7) In either environment, specific notations not populated by the EMR would be entered by the staff member or patient, and combined with the existing notations and diagnosis codes in the EMR, to populate the Mirror database. (8) Content is queried from the database according to practice and provider predefined preference, patient diagnosis, staff entered categories of content, and demographics. Such a query obtains corresponding health specific content with matching applied notations to be displayed (9) on the Mirror Endpoint Interface (10) in exam room for the patient (11) to view while waiting for an impending physician encounter. Alternatively, the corresponding health specific content with matching applied notations, or link to such, could be displayed on a mobile device or link sent to an email address (19). In an embodiment, the Mirror Endpoint Interface includes a browser or software application running on the display device shown in FIG. 1.

If there is no interaction with the display device (Mirror Endpoint Interface) the display device can generate sequential display of these images. Interaction (13) with the display device (Mirror Endpoint Interface) can be used to generate specific images, e.g., health specific content, to be being viewed by the patient. Information regarding what is displayed and any interaction with the display is logged (14) to the Mirror database in accordance with the patient's identifier and stored for further analysis. A patient's preferred contact information (15) such as an email address or phone number could be entered by the patient on the display. This interaction would generate the polled content (16) to be sent to that contact information from the database, such as follow-up information or a reminder. The contact information does not need to be stored in the Mirror database.

As part of the office workflow, following staff interaction with the Health Mirror staff interface, the patient would be escorted to the exam room (17). Alternatively, in an environment with a Kiosk, the patient would be directed to the indicated exam room (18) by the Kiosk after interaction with a Kiosk interface.

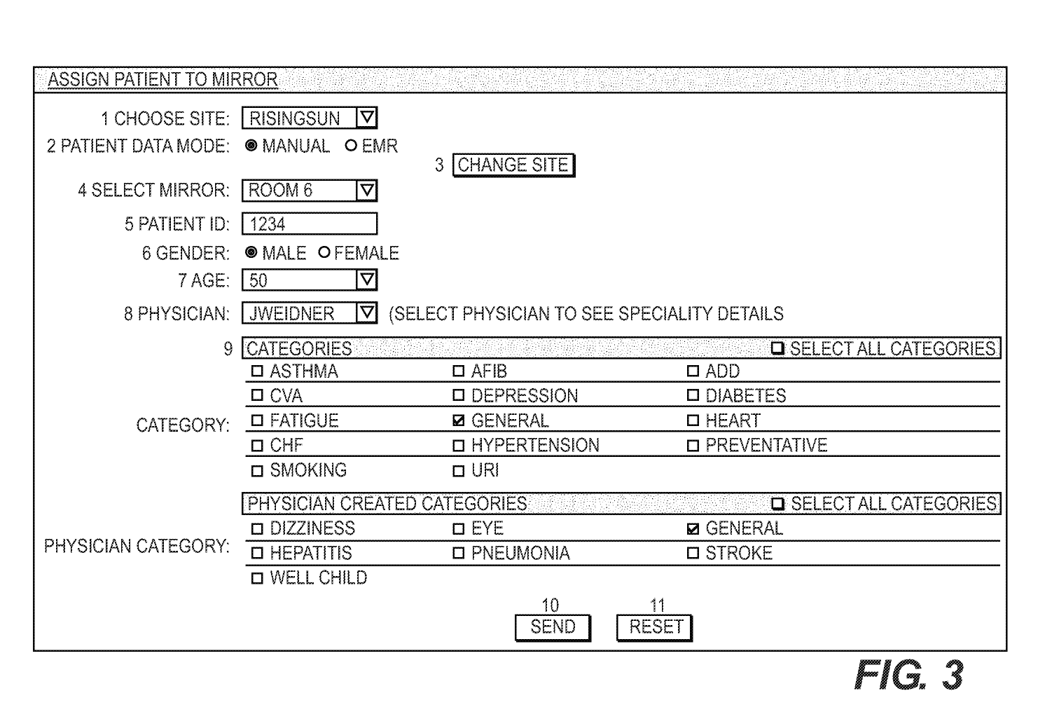

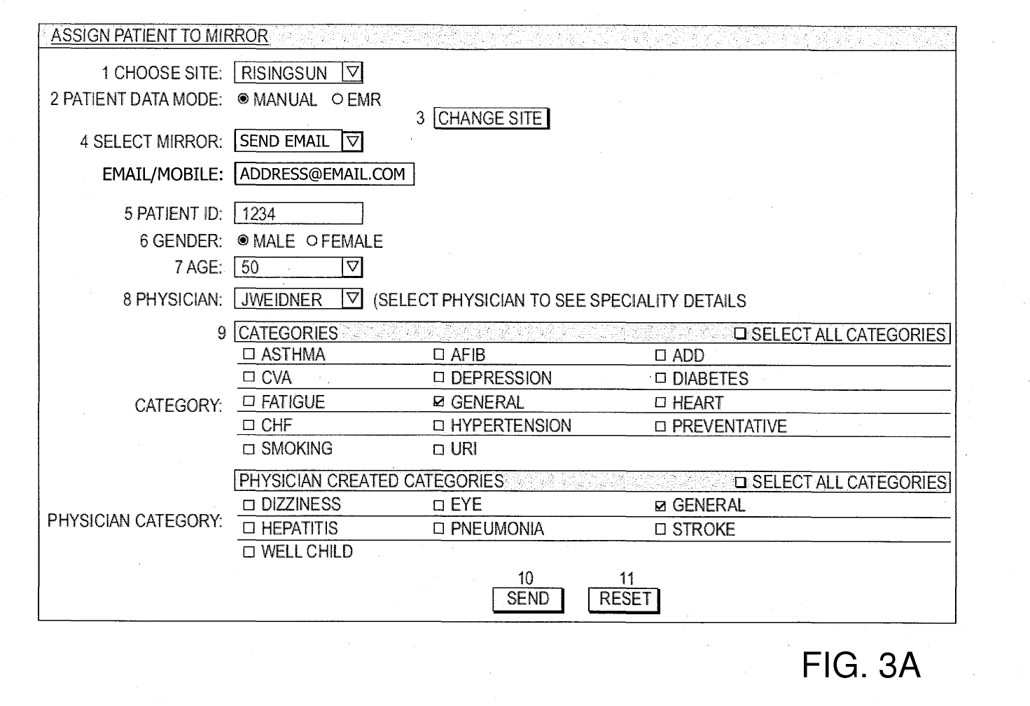

FIG. 3 is an example browser for entering patient information. The information shown in FIG. 3, is an example and the present invention is not limited to the particular example shown in FIG. 3. Referring to the example of FIG. 3, reference numeral 1 identifies a “Choose site” dropdown box with a cookie that will remember to selection for a given staff's login. The staff can select different practices that they are affiliated with.

In FIG. 3, reference numeral 2 identifies a “Patient data mode” selection button for choice of operational mode, which would select where the patient characteristics, including demographics and preexisting diagnosis codes would be populated. The “Manual” selection button allows a staff member to select the room (which would correspond with the device identifier number in that exam room), patient identifier, gender (of the patient), age (of the patient), physician (that the patient is seeing), and categories of health content. The “EMR” selection button can initiate the running of a script that can query the EMR database using the patient identifier to obtain the gender, age, and stored diagnosis codes. The room and physician as well as the patient identifier are placed in the appropriate fields by the staff.

In FIG. 3, reference numeral 3 identifies a “Change Site” button that allows the operator (e.g., staff) to choose a different site, if using a entry device that moves to different sites. Selecting the button will allow the information for reference numerals 1 and 2 to be changed. The fourth box, identified by reference numeral 4 identifies a “Select Mirror” dropdown box that will allow selection of the exam room the patient is assigned to. This will be limited to registered end point devices (i.e., devices such the Mirror endpoint interface shown in the Figures that have device identifiers stored by the system. In FIG. 3, reference numeral 5 identifies a “Patient ID” text box to type patient identifier (e.g. a number or other identifying character string or bar code number) in order to query demographics and also to generate reports about patient interaction with content.

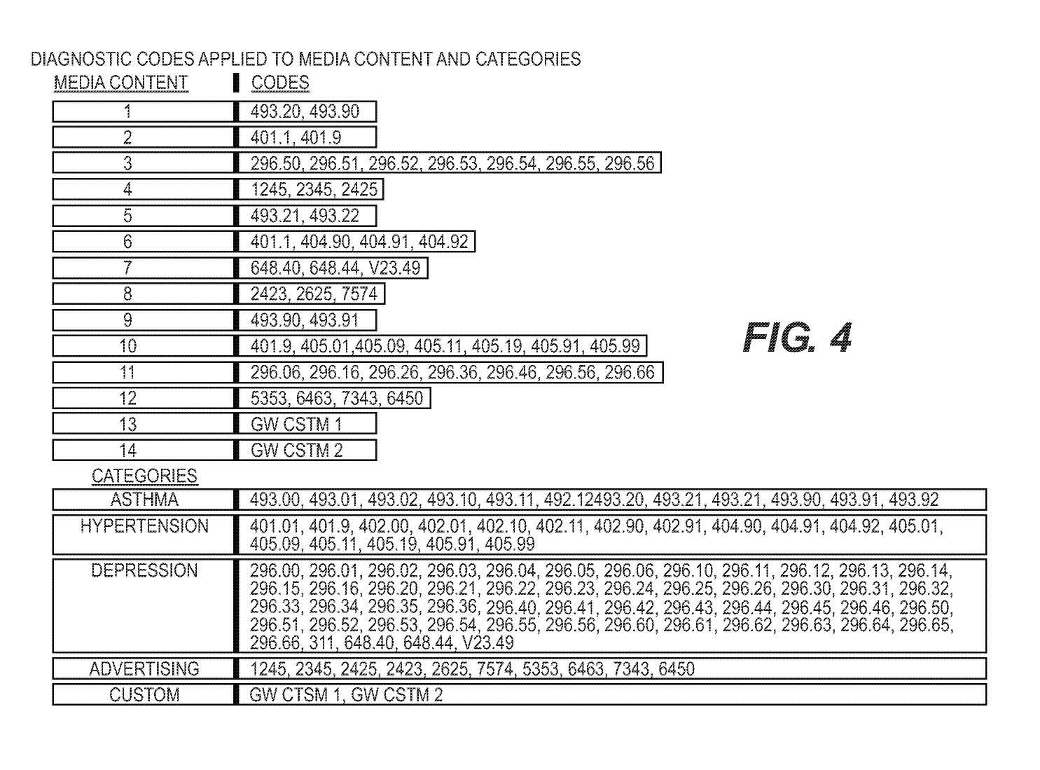

Reference numeral 6 in FIG. 3 identifies a “Gender” radio button used in manual mode to select if the patient is male or female to query gender specific content. Reference numeral 7 identifies an “Age” input area used in the manual mode where a patient's age can be entered to query age specific content. Reference numeral 8 identifies a “Physician” dropdown box selecting physician in this field, it would be used to query the categories available, according to the doctor's specialties, and preferences setup by the practice and physician, and others created by the physicians. The available categories are displayed in the area identified by reference numeral 9. The area 9, “Categories,” includes multiple check boxes which list categories of content. Each category is based on grouping of categories associated with, for example, diagnostic codes (e.g., FIG. 4), which can be established by the practice and/or physician. The categories are groupings of diagnosis codes that have content assigned according to the diagnosis codes assigned to the content as schematically shown in FIG. 4. Reference numeral 10 identifies a “Send to Mirror” button that compiles data selected then queries the Mirror database for the content to be displayed on the selected Mirror (endpoint interface) such as shown in FIG. 1. FIG. 3.1 shows the appearance of another field that would display below the “send to Mirror” button, allowing the entry of an email address or number of a mobile device. The “Reset” button (11) allows the resetting of all the non-preset fields back to default.

FIGS. 4 through 7 schematically illustrate the relationships of information stored in the Mirror database. The Mirror database stores media content to be displayed on a selected one, or ones, of the Mirror (endpoint interface) devices, one of which is shown in FIG. 1. Within the database, each file of media content has associated patient characteristic, such as patient demographics, diagnostic and other codes. Diagnostic codes can include ICD-9 codes and other diagnostic codes. These diagnostic codes are also associated with categories, such as illustrated in FIG. 3. Diagnostic codes are associated with media content and categories. FIG. 4 shows one example of such associations. In FIG. 4, the various media content are associated with diagnostic codes that have been assigned to the respective media content. The diagnostic codes can be matched in a query using patient characteristics (e.g. a diagnostic code for the patient) to identify media content to display on the Mirror (endpoint interface) device in the exam room assigned to the patient, i.e., on the device having the specified device identifier.

Also shown in FIG. 4 are associations of example categories with predetermined diagnostic codes. Thus, if in a category “Asthma” was selected in FIG. 3, the diagnostic codes shown in FIG. 4 would be associated with the patient and the media content associated with those diagnostic codes (e.g., such as shown in FIG. 4) would be displayed to the patient.

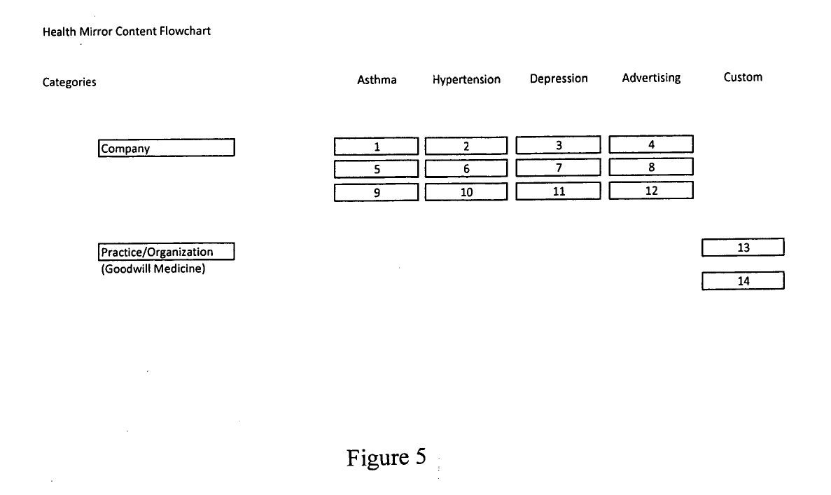

FIG. 5 shows how media can be associated with categories, according to the diagnostic codes that are associated with the categories. Content created by the company is separated from the custom content created for the practice “Goodwill Medicine”. Referring to FIG. 5, Asthma has associated with it media content, 1, 5, and 9. This association is based on the diagnostic codes for the category shown in FIG. 4. Referring to FIG. 4, Media content 1, 5, and 9 have respectively associated therewith diagnostic codes 493.20, 493.21, and 493.90. These three diagnostic codes are also associated with the category Asthma shown in the Categories portion of FIG. 4. The other associations shown in FIG. 5 are developed in a similar manner. It is not necessary to use diagnostic codes to select media content. While, diagnostic codes are discussed with respect to this illustrative embodiment, any other patient characteristic can be used in place of or in addition to diagnostic codes.

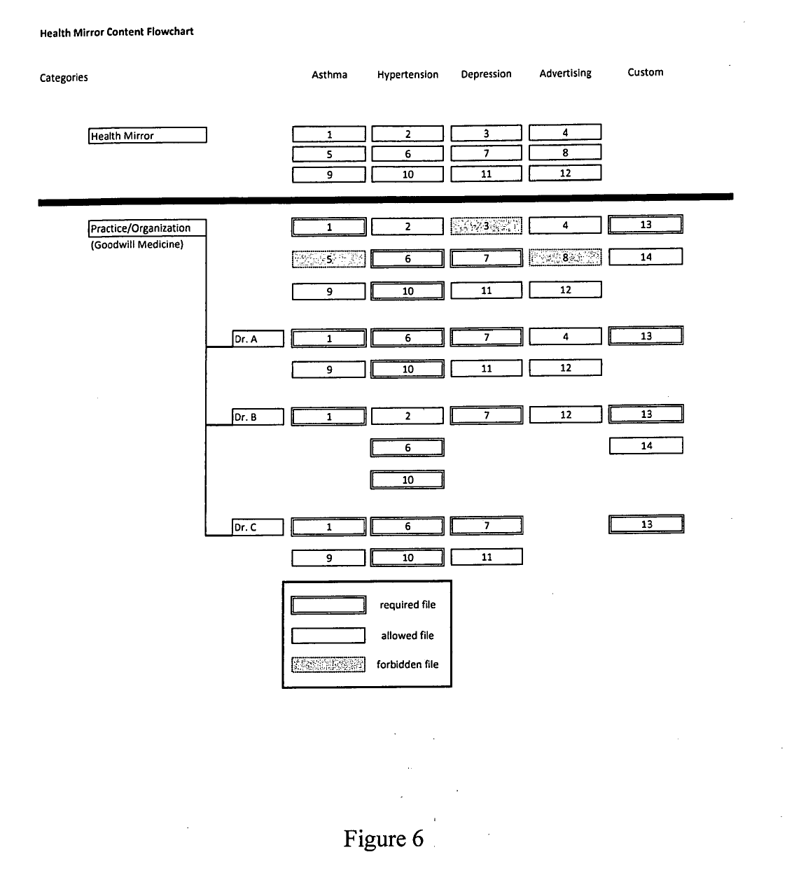

FIG. 6 shows how rules can be applied to determine what media content that is associated with patient characteristics (e.g. diagnostic codes) is displayed on the Mirror (endpoint interface) determined by the device identifier. The rules can have any desired structure. In the illustrative embodiment there are practice and physician rules. For example, the practice can select permissions to apply to each of the company's media content files, as well as any custom files. In the illustrative embodiment a practice has three levels of content rules: required, allowed and forbidden. Indicating that a file is a required file will designate that specific media content file will be displayed for each patient that has a corresponding characteristic, regardless of the physician's preference. Indicating that a file is a forbidden file prevents that file from being displayed. Designating a media content file to be an allowed file will subsequently allow each physician to select whether to have that designated media file displayed or forbid it from being displayed. In FIG. 6, the outline to the box corresponds to whether the content is required, allowed or forbidden.

As an example, Goodwill Medicine has three doctors in its practice: doctors A, B, and C. The practice has determined that the media content 1, 6, 7 and 10 is required to be displayed. They have forbidden content 3, 5 and 8 from being displayed. They have allowed the media content 2, 4, 9, 11, and 12 to be displayed at the discretion of each doctor. Also, they have custom made content 13 that they require to be displayed, and also custom made media content 14 to be displayed at the discretion of each doctor.

Therefore, for doctors A, B and C, they each have 1, 6, 7, 10 and 13 displayed to their patients, as required by the practice. Doctor A has selected media content 4, 9, 11, and 12 to be displayed, but not media content 2 or 14. Doctor B has selected media content 2, 12 and 14 to be displayed, but not Media content 4, 9, or 11. Doctor C has selected Media content 9 and 11 to be displayed, but not Media Content 2, 4, 12, or 14.

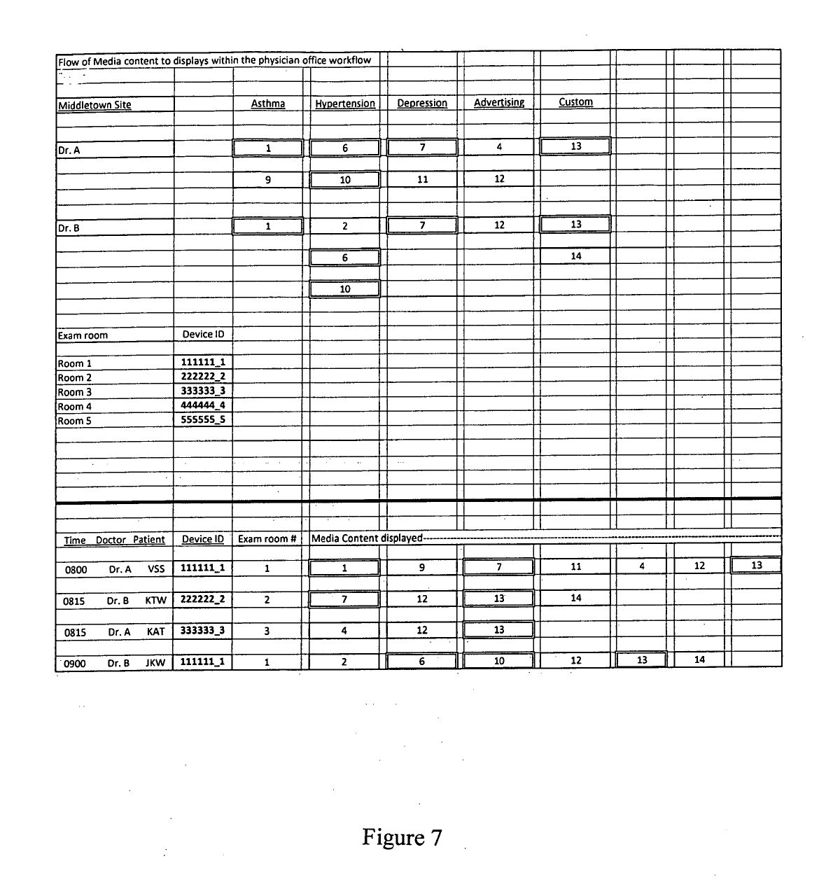

FIG. 7 shows an example of the rules / permissions determining the media content that is displayed on the specific devices that correspond to the exam room that a patient assigned to for examination by a specific doctor. The permissions applied to the media content from FIG. 6 are seen at the top of FIG. 7 for corresponding physicians. In this example, the site has five exam rooms with Mirror (endpoint interface) devices in each exam room. Each device has a unique identifier. Doctors A and B are each seeing patients at the Middletown site simultaneously. For each patient, as part of the workflow of the practice, the staff places information into the staff interface, as described further and shown with respect to FIG. 3. This information applies patient characteristics (e.g., demographic information, diagnostic codes specific to the patient) as well as the exam room and the physician the patient is about to see. Thus patient specific content is presented by a browser running in the Mirror (endpoint interface) device in the exam room that the patient is assigned to. This information can be a description of the physician visit—content specific to the demographics and diagnoses of the waiting patient, according to the permissions of the practice and the selection of the physician they are about to see.

FIG. 7 provides an example of this process. At 0800, the clinical staff places a patient VSS in exam room 1 for Dr. A to see. The patient VSS has diagnostic codes applied that fall into the categories of Asthma and Depression. Subsequently VSS is shown the practice required and physician allowed media content on the device in exam room 1, that corresponds to the diagnostic codes of asthma (1,9) and depression (7,11), as well as the advertising (4,12) and custom content (13).

At 0815, the clinical staff places KTW in exam room 2 for Dr. B to see. The patient KTW has diagnostic codes applied that fall into the categories of Depression. Subsequently KTW is shown the practice required and physician allowed media content on the device in exam room 2, that corresponds to the diagnostic codes of depression (7), as well as the advertising (12) and custom content (13,14).

Also at 0815, the clinical staff places a patient KAT in exam room 3 for Dr. A to see. The patient KAT has no diagnosis, so none are applied by the staff. Subsequently KAT is shown the practice required and physician allowed advertising (4,12) and custom content (13) on the device in exam room 3.

Then at 0900, the clinical staff places patient JKW in exam room 1 for Dr. B to see. The patient JKW has diagnostic codes applied that fall into the categories of hypertension. Subsequently JKW is displayed the practice required and physician allowed media content on the device in exam room 1, that corresponds to the diagnostic codes of hypertension (2, 6,10), as well as the advertising (12) and custom content (13,14)

As discussed above, the corresponding health specific content with matching applied notations, or link to such, could be displayed on a mobile device or link sent to an email address (19), via e.g., the user interface shown in FIG. 3.1. Accordingly, the manner in which the above-described content is provided to patients VSS, KTW, KAT, JKW may alternatively or additionally include being provided via a link (in the form on an email) or to a mobile device (e.g., in the form of a text message).

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A method of providing patient specific content, comprising:
storing desired health related information;
obtaining patient characteristics;
obtaining health related information in accordance with the patient characteristics; and
providing the obtained health related information to the patient.

2. The method of claim 1 wherein storing desired health related information includes storing in a database health specific and practice specific content, and storing in the database links to health specific and practice specific content.

3. The method of claim 2 wherein storing desired health related information includes storing health content and links to health content generated by specific practice and physician users.

4. The method of claim 1 further comprising one or more of:
applying specific codes to the health specific content, including tagging the health specific content with existing diagnosis codes or other health identifiers, and
applying gender, age and other demographic codes to the health specific content.

5. The method of claim 4 wherein tagging the health specific content is based at least in part upon one or more of:
disease management,
disease and injury prevention,
disease screening,
health recommendations,
practice policies,
practice promotions, and
entertainment.

6. The method of claim 1 wherein providing the obtained health related information is in accordance with predetermined rules.

7. The method of claim 5 wherein the predetermined rules include one or more of:
practice determined permissions to content to require or forbid providing predetermined health specific content;
physician determined permissions to content to require or forbid providing predetermined health specific content;
categories of specific applied diagnosis and demographic codes that correspond with specific diagnosis and demographic codes of the health specific content; and
a specific physician specialty for each category to limit the use of the health specific content to a specified category to the physicians of that specialty.

8. The method of claim 7 wherein the categories include at least one of creation, management, and selection of categories by the practice and physician, designation of appropriate physician specialty, selection of disease and demographic codes to the categories by a practice and physician, diagnosis codes in common with the categories.

9. The method of claim 7 wherein obtaining health related information includes running a script that performs at least one of: queries the database by a patient identifier to obtain demographics and diagnosis codes, selects the health specific content based on at least one of demographics and diagnosis codes within an electronic medical record database; and selects practice-specific and physician specific health specific content.

10. The method of claim 1 further comprising:
obtaining identification of the patient and entering the identification into a database;
selecting at least a plurality of a patient identifier, an exam room, an email address, a mobile device number and physician and entering into a database;
selecting at least one diagnosis category and entering into a database; and
entering into a database patient characteristics.

11. The method of claim 10 wherein providing the obtained health related information includes displaying the obtained health related information on a software application or a browser based on a predetermined device identifier.

12. The method of claim 1 further comprising:
displaying a prompt on a display running a browser to enter patient interaction and receiving the patient interaction information,
displaying on the device instructions to enter into the device patient information including at least one of phone, email and contact information, and receiving ;the patient information, and
sending a link of query strings that corresponds to the patients information.

13. The method of claim 12 further comprising:
generating reports of patient viewing and interaction of content.

14. The method of claim 13 wherein generating reports includes:
generating reports based on patient interaction and usage data.

15. The method of claim 14 wherein generating reports includes:
storing patient interaction data in a patient record within an electronic medical record.

16. The method of claim 1 wherein providing the obtained health related information to the patient includes:
providing the obtained health related information to the patient at the point of care.

17. The method of claim 1 wherein providing the obtained health related information to the patient includes:
providing the obtained health related information to the patient at a remote location.

18. A method of providing patient specific content, comprising:
storing desired health related information;
obtaining patient characteristics;
obtaining health related information in accordance with the patient characteristics; and
providing the obtained health related information to the patient at the point of care.

19. A method of providing patient specific content, comprising:
storing desired health related information;
obtaining patient characteristics;
obtaining health related information in accordance with the patient characteristics; and
providing the obtained health related information to the patient at a remote location.
